(19) United States
(12) Patent Application Publication
(10) Pub. No.: US 2005/0158008 A1
(43) Pub. Date: Jul. 21, 2005

(54) Free space MSM photodetector assembly

(75) Inventors: Torsten Wipiejewski, Hong Kong (CN); Allan Hui, Hong Kong (CN); Frank Tong, Hong Kong (CN)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: SAE Magnetics (H.K.) Ltd., Hong Kong (CN)

(21) Appl. No.: 10/932,565

(22) Filed: Sep. 2, 2004

Related U.S. Application Data
(60) Provisional application No. 60/500,655, filed on Sep. 5, 2003.

(51) Int. Cl. G02B 6/00

(52) U.S. Cl. 385/147

(57) ABSTRACT

One embodiment of the invention uses an MSM photodetector for light that is transmitted over a free space medium. The MSM photodetector with its low capacitance enables high speed data transmission and large alignment tolerances.

### RELATED APPLICATIONS

This application claims priority to U.S. Patent Application Ser. No. 60/500,655, entitled ‘FREE SPACE MSM PHOTODETECTOR ASSEMBLY,” filed Sep. 5, 2003, is related to co-pending and commonly assigned U.S. patent application Ser. No. 10/655,752, entitled “MSM PHOTODETECTOR ASSEMBLY,” filed Sep. 5, 2003, the disclosure of which is hereby incorporated herein by reference.

### FIELD OF THE INVENTION

This application relates in general to optical communication, and in specific to an assembly for an MSM photodetector.

### BACKGROUND OF THE INVENTION

Optical fiber technology is well suited for communications applications because optical fibers have a wide transmission bandwidth and relatively low attenuation. However, optical fiber interfaces to electronic and optical networks are expensive to manufacture because of the difficulty associated with mounting laser transmitting and receiving devices onto substrates and aligning them with separately mounted optical fibers. The difficulties generally are associated with manufacturing components with precise tolerances and mounting components at precise locations within precise tolerances. The challenges of alignment are typically faced during the packaging of the devices. To overcome these difficulties, the transmitter and receiver devices can be enlarged so as to alleviate the tight tolerances that are difficult to achieve during alignment.

In a conventional optical fiber communications system, a transmitter sends optical data into a fiber, and the data is received by a detector at the receiving end. An inherent interface exists at each end of the fiber. Minimizing the optical loss at these two interfaces is difficult due to the alignment at the micron scale. Alleviating the alignment tolerance at the transmission end can be done by enlarging the core of the optical fiber. However, this has an undesirable effect at the receiving end interface. Namely, the light that However, this has an undesirable effect at the receiving end interface. Namely, the light that exits a larger core fiber has a larger cross-sectional area, thereby making it difficult to capture the light.

Large core fibers, e.g. fibers with core diameters of 50 to 63 microns, are typically found in local area network (LAN) environments. The large cores provide more tolerances for installation than smaller core fibers, e.g. coupling the fiber to a source laser or a receiving photodetector, as well as coupling fibers together with an optical connector. Two types of photodetectors are typically used to receive the light from the fiber and convert the light into an electrical signal, namely a PN diode and a metal semiconductor metal (MSM) diode. Both are currently made to be about 70 to 80 microns in diameter, so as to capture the light from the LAN fibers.

Another type of fiber is being used in limited applications, namely the hard clad silica fiber (HCS) fiber. This fiber has a silica core surrounded by a hard plastic cladding and has diameters of typically 200-300 microns.

A further type of fiber is a plastic fiber. This fiber is similar to the HCS fiber, but uses a plastic core instead of a silica core. Since the core is plastic, the attenuation of the fiber limits effective use of the fiber to distances of 10 meters or less.

Accordingly, there is a need for an optical receiving assembly that incorporates all the necessary optical and electrical components to capture the light exiting the large area fiber of a low cost platform.

### BRIEF SUMMARY OF THE INVENTION

Embodiments of the present invention are directed to a system and method which is associated with an optical-to-electrical signal conversion device used for receiving data in communications. Embodiments of the invention are particularly low cost in packaging due to their formation in a resin molded leadframe with integrated optical and electrical components. Embodiments of the invention use a large, high speed photodetector.

According to the present invention, a large area metal-semiconductor-metal (MSM) photodetector(s) is used to capture the light from a light source inside a connectorized package assembly. The inventive MSM photodetector can receive a single optical channel using a single detector or multiple optical channels using an array of detectors. The MSM photodetector converts the optical signal into electrical signal, in each respective channel. The electrical signal is amplified via an integrated circuit chip or a separate discrete chip inside the same package.

Embodiments of the invention may include a lens to focus the light onto the detector. Embodiments of the invention have the photodetector mounted an a substrate, e.g. a printed circuit board, a lead frame substrate, a RF ceramic substrate, or a silicon substrate.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a schematic of an optical system using an embodiment of the invention;

FIG. 2 is a schematic of an example of a photodetector according to embodiments of the invention;

FIG. 3 is a schematic of another example of a photodetector according to embodiments of the invention; and

FIG. 4 is a graph comparing MSM photodetectors and a pin photodiode.

### DETAILED DESCRIPTION OF THE INVENTION

Embodiments of the invention would operate in situations that need short, high speed optical data links, e.g. 30 meters or less, across free space mediums, without a wire or fiber medium. For example, embodiments of the inventor could be used in entertainment systems, computer systems, automotive systems, transportation systems, storage systems, industrial systems, aviation systems, multimedia systems, information technology systems, etc. For example, embodiments of the invention could link two computer systems together, link two computer boards together, connect a DVD player to a TV (Which may be located in a building, car, train, airplane, or other transportation system), connect a tuner/control unit to a large panel TV monitor, link a game controller to a game box, connect a house hold appliance (e.g. a TV, stereo, telephone, computer, camera, etc.) to a control system, connect a digital camera to storage or control system or a display screen, connect a sensor to a computer, connect a control mechanism to a computer, connect a computer to a projector or monitor, or connect devices to a multiplexer or demultiplexer. Furthermore, embodiments of the invention may be used with large screen devices like high definition TV (HDTV) sets that use high speed connections to the control unit.

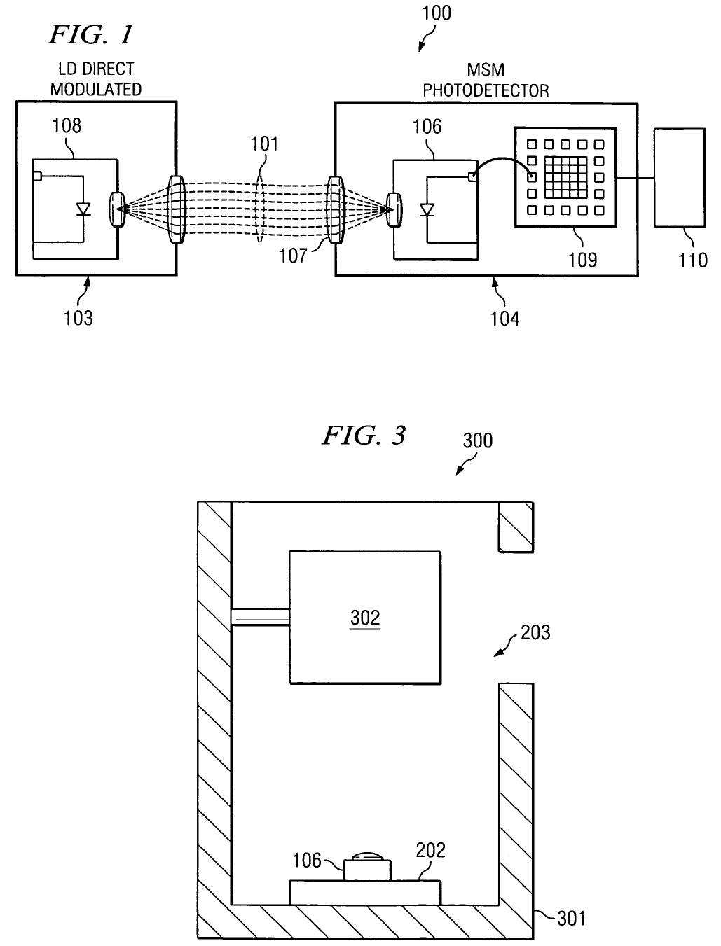

FIG. 1 depicts an arrangement for an optical communications system 100 using an embodiment of the invention. The system 100 includes a free space medium 101, e.g. air or vacuum. In this system, a light signal is directed onto the photosensitive area of a photodetector. The light signal may be collimated or focused. The alignment tolerance of such a system is increased with a large area photodetector. Thus, the larger the photodetector, the less exact the alignment of the photodetector with light signal needs to be. With larger alignment tolerances, placement of the photodetector with respect to the light signal transmitter becomes easier. However, the larger the photodetectors, the lower the bandwidth becomes. Embodiments of the present invention increase the maximum bandwidth and alignment tolerance of the free-space optical receiver unit. The system may have a bandwidth of from 5 megabits per second to 5 gigabits per second, depending on the size of the photodetector.

System 100 uses transmitter 103 to generate and couple the light used for the signal into the free space medium. The transmitter 103 would form modulated light which is then coupled into the medium. This light would carry information through the medium 101 in the form of light pulses. The light may be formed by laser 108, which may a diode laser, in the form of a Fabry-Perot (FP) laser, or a vertical-cavity surface-emitting laser VCSEL. The light source could also be a high speed light emitting diode (LED). Typically, the light generated will have a wavelength from 500-1550 nanometers. Most systems will operate at around 650 nm, 780 nm, or 850 nm, 1300 nm wavelengths.

The light pulses would be detected by the receiver 104. The receiver includes photodetector 106, which may be an MSM photodetector. The photodetector would then convert the light signal into an electrical signal. The electrical signal may then be sent to another receiver component 109, e.g. an amplifier, filter, and/or other processing component, and/or the signal is (then) sent to off-receiver component 110, which may be an amplifier, filter, and/or other processing element.

Optionally, the receiver 104 may include lens 107 which would focus the light onto the photodetector.

An MSM photodetector is preferable over a p-intrinsic-n (PIN) photodetector. As the size of a PIN-type photodetector is increased, the capacitance is increased, effectively lowering the bandwidth or speed of the system. Thus, for speeds of more than 1 gigabit per second, the typical diameter of a PIN photodetector would have to be less than 100 micrometers. Because of the geometrical configuration of the MSM photodetector, it has much lower capacitance than a PIN photodetector of the same size. Thus, the MSM photodetector may be larger than 100 micrometers and still allow for speeds in excess of 1 gigabit per second.

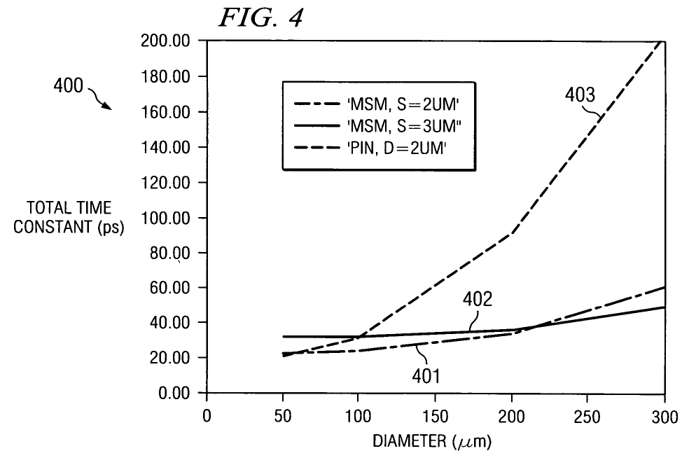

The graph 400 in FIG. 4 shows a comparison of the calculated time constants of two MSM photodetectors with an electrode spacing of 2 μm (401) and 3 μm (402) respectively, and a pin photodiode (403) with an absorbing layer thickness of 2 μm. Note that the MSM detector is significantly faster for diameters of 150 μm and above. For smaller diameters the drift time is more dominant, and therefore, the speed of the pin-diode is comparable with the MSM detector.

An MSM photodetector may comprise gallium arsenide that is basically undoped, for shorter wavelengths (e.g. 650, 780, 850 nanometers or visible to near infrared). The photodetector may also comprise indium phosphide or similar material for longer wavelengths (e.g. 1.3 micrometers, 1.55 micrometers or higher). Typical metal for the electrodes may be platinum with a gold layer on top A titanium layer beneath improves the adhesion to the semiconductor. Thicknesses of the titanium would be in the range of 20 nanometers, the platinum would be typically 100 to 200 nanometers and the gold layer typically would be another 200 nanometers to 1 micron. The purpose of the electrodes is to collect the carriers generated in the semiconductor. The electrodes also form a Schottky barrier to the semiconductor. The width of the electrodes would be as small as possible in order to have the least amount of light blocking. The typical width of these electrodes is in the range of 1 micron or lower, e.g. 0.7 microns. The space in between the two electrodes on the top surface would need to be optimized for the specific application of the photodetector. The longer the distance the more voltage is needed to operate the device. Typical distances between the electrodes is 1 to 3 microns. MSM photodetectors may also have an anti-reflective (AR) coating on the top surface to minimize light loss due to reflection at the surface. The AR coating layer is adjusted to a quarter wave length thickness and the effective index is the geometrical average between the air (or other encapsulant) and the semiconductor. The typical number for the effective index is 1.9.

FIG. 2 depicts an example of an exploded view of a MSM photodetector and a connector 201 according to embodiments of the invention. This arrangement 200 includes a port or opening 203, by which the light is received by an array of photodetectors 106 from the free space medium. A plurality of lenses 107 focus the light onto the array of photodetectors 106. The lenses 107 may be separate from the array or they may be integrated with the array. The array is attached to a substrate 202, which can be a PCB, a silicon substrate, a ceramic substrate, a dielectric substrate, or a metal frame substrate.

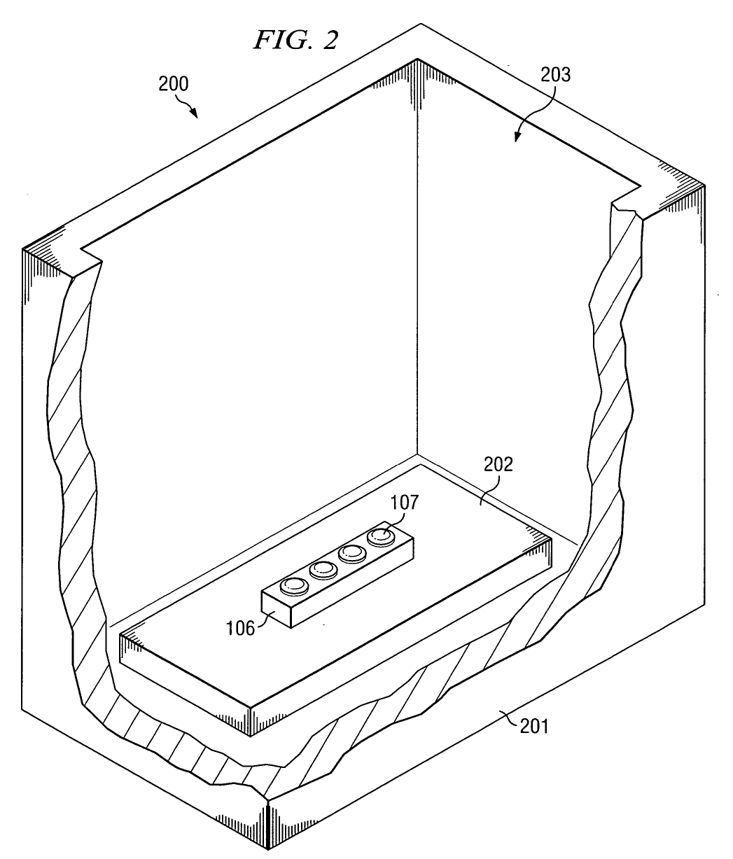

FIG. 3 depicts an arrangement 300 similar to that of FIG. 2, but uses element 302 that reflects the light at an angle with respect to the direction of its entrance into the connector 301. Note that element 302 may also focus the light as with lens 107, in addition to changing its direction. Further note that the 90 degree change is by way of example only as other angles could be used.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A system comprising:
a light source that provides a light signal, which is light that comprises a data signal;
an optical free-space medium to transport a light signal; and
a metal semiconductor metal (MSM) photodetector that receives the light signal;
wherein the system has a data rate of at least 500 Megabit per second.

2. The system of claim 1, further comprising:
a lens that focuses the light signal onto the MSM photodetector.

3. The system of claim 1, wherein the system has a data rate of at least 1 Gigabit per second.

4. The system of claim 1, wherein the MSM photodetector has a GaAs substrate.

5. The system of claim 1, wherein the MSM photodetector has an InP substrate.

6. The system of claim 1, wherein the MSM photodetector has one of a GaN, a Sapphire, and a SiC substrate.

7. The system of claim 1, wherein the medium has an optical axis that is parallel to an optical axis of the MSM photodetector.

8. The system of claim 1, further comprising:
a reflector that reflects the light signal onto the MSM photodetector at an angle with respect to a direction of the light signal.

9. The system of claim 8, wherein the angle is 90 degrees.

10. The system of claim 8, wherein the reflector focuses the light signal onto the MSM photodetector, and the MSM photodetector has a diameter that is less than the diameter of the optical waveguide.

11. The system of claim 1, wherein the system is associated with one of an entertainment system, a computer system, an automotive system, a transportation system, and a storage system, an industrial system, an aviation system, a multimedia system, and an informational technology system.

12. The system of claim 1, wherein the system connects a signal provider to an receiving unit.

13. The system of claim 12, wherein the signal provider is selected from the group consisting of:
a cable system, DVD player, video cassette player, a CD player, a controller, a sensor, communications system, a data storage device, and a multiplexer.

14. The system of claim 12, wherein the receiving unit is selected from the group consisting of:
stereo system, a television, a computer, a personal data assistant, game system, telephone, a household appliance, a display screen, a control system, a demultiplexer, and a digital recorder.

15. The system of claim 1, further comprising:
a substrate upon which the MSM photodetector is mounted.

16. The system of claim 15, wherein the substrate is one of a printed circuit board, a lead frame substrate, a RF ceramic substrate, and a silicon substrate.
